(19) United States
(12) Patent Application Publication
(10) Pub. No.: US 2025/0162187 A1
(43) Pub. Date: May 22, 2025

(54) Method of Mechanically Processing Bamboo Splits Obtained From Bamboo Culm; A Bamboo Product Obtained Using Such a Method; And a Processing System for Processing Bamboo Splits

(71) Applicant: Moso International B.V., Zwaag (NL)

(72) Inventors: Jacob Hendrik Van Der Vegte, Zwaag (NL); Ireneus Alexis Wilhelmus Zaal, Zwaag (NL)

(21) Appl. No.: 18/841,692

(22) PCT Filed: Feb. 16, 2023
(86) PCT No.: PCT/NL2023/050074

§ 371 Date: Aug. 27, 2024

(30) Foreign Application Priority Data
Feb. 28, 2022 (NL) 2031094

(51) Int. Cl. B27J 1/00

(52) U.S. Cl. CPC B27J 1/00

(57) ABSTRACT

[symbol]

of mechanically processing a bamboo split which is a segmental and longitudinal part of a bamboo culm,
by which method a bamboo strip is produced [symbol] method
providing a bamboo split which has an inner skin layer and outer skin layer and a central bamboo layer in between;
mechanically removing bamboo node diaphragms present on the inner skin layer of the bamboo split;
mechanically removing the inner skin layer and outer skin layer from the bamboo split
least the part of the inner skin layer adjacent to the central bamboo layer is removed by mechanical abrading, and optionally the complete inner skin layer is removed by mechanical abrading.

### CROSS-REFERENCE TO RELATED APPLICATIONS

This application is the United States national phase of International Application No. PCT/NL2023/050074 filed Feb. 16, 2023, and claims priority to The Netherlands Patent Application No. 2031094 filed Feb. 28, 2022, the disclosures of which are hereby incorporated by reference in their entireties.

### BACKGROUND OF THE INVENTION

### Field of the Invention

The present invention relates to a method of mechanically processing a bamboo split which is a segmental and longitudinal part of a bamboo culm, by which method a bamboo strip is produced, and the method comprises the following steps:
a) providing a bamboo split which has an inner skin layer and outer skin layer and a central bamboo layer in between;
b) mechanically removing bamboo node diaphragms present on the inner skin layer of the bamboo split;
c) mechanically removing the inner skin layer and outer skin layer from the bamboo split in order to obtain a bamboo strip.

In the field of manufacturing bamboo products from raw bamboo, the processing of a bamboo split in order to produce a bamboo strip is a first basic step. The processing method is directed to converting the raw material of a bamboo split into a bamboo strip that mainly consists of the original central bamboo layer of the bamboo split.

The material of the central bamboo layer can be characterized as an essentially uniform or pure material, which is based on a unified matrix of lignocellulose fibers. Additional to this central bamboo layer, the raw bamboo split includes other bamboo culm structures such as node diaphragms and an inner skin layer and an outer skin layer. These other structures are made from particular types of bamboo material which have different properties in comparison to the material of the central bamboo layer.

In order to obtain a bamboo strip that is formed out of a relatively uniform type of bamboo material, the removal of these other structures of the bamboo culm is necessary, and requires two basic processing steps:

First, the bamboo node diaphragms which form in the original bamboo culm intermittent transversal structures and are still present on and connected to the inner skin layer of the bamboo split, are removed by mechanically cutting off;

Second, the inner skin layer and outer skin layer are removed by mechanically cutting off.

For the sake of clarity, it is noted that the bamboo splits and the bamboo strips are formed by longitudinal sections of the bamboo culm, and thus have a longitudinal form themselves. Typically, the processing method is performed while the bamboo splits and bamboo strips are transported in a direction that aligns with the longitudinal orientation of the bamboo splits and bamboo strips.

### Description of Related Art

It is noted that most technical terms that are used throughout this description are derived from the applicable norm ISO 21265:2020 which includes a publicly available vocabulary for bamboo and bamboo products.

In the prior art, the processing of bamboo splits involves the removal of the inner skin layers and outer skin layers by cutting off the skin layers using knives, in particular rotary knives, such as milling cutters (a rotating wheel or cylinder having knives with cutting edges arranged parallel to the axis of rotation).

The cutting off technique by such knives is however a relatively coarse technique and therefore has drawbacks in view of achieving a complete removal of the skin layers: when the cutting off technique is applied, about 5 wt. % or more of residual skin layer material is found remaining in the obtained bamboo strip. This imperfect result has been particularly noticeable in respect of the removal of the inner skin layer. It was observed that the imperfect removal mainly related to skin layer residues that directly border on the central bamboo layer, i.e. the parts of the skin layer adjacent to the central bamboo layer and which are directly connected thereto.

A first, although not attractive, option to make sure that no residual skin layer remains present in the bamboo strip, is to apply the relatively coarse cutting off technique over a larger thickness of the bamboo split (i.e. cutting off to a deeper extent) than merely the inner skin layer so that a first part of the central bamboo layer adjacent to the inner skin layer is removed as well. However, such an option would lead to structural losses of central bamboo material which is disadvantageous and makes the method less viable.

The importance of a virtually complete removal of the skin layer when processing bamboo split into bamboo strip, relates to subsequent processing steps of the bamboo strip which are explained below.

In the manufacturing of bamboo scrimber products, it is typically required that the production of a bamboo strip is followed by a crushing treatment of the bamboo strip in order to create a bamboo fiber bundle strip. The crushing is performed by exerting high pressure on opposed surfaces of the bamboo strip, for instance by leading the strip between two opposed rollers creating high pressure by its own weight or added force which are actuated against the respective sides of the bamboo strip. The obtained fiber bundle strip can be used as an elementary, starting material for various applications, and is mainly composed of longitudinal cross-linked fiber bundles. These cross-linked fiber bundles were originally present in the central bamboo layer as one piece of unified bamboo fibers. During the crushing treatment by high pressure rollers the central bamboo layer material is partially fragmented into separate longitudinal fiber bundles, which are still partially cross-linked to each other at certain positions along the length of these fiber bundles.

Subsequent to the crushing treatment, the bamboo fiber bundle strip may be subjected to various additional treatments which include a heat treatment, an impregnation with a fluid material, and/or a compressing treatment, in order to produce a bamboo product that is suitable for specific, final applications.

In the above context of manufacturing bamboo products, the presence of a significant amount of residual skin layer material in a produced bamboo strip has been identified as potentially detrimental in view of the quality of the bamboo product that is eventually manufactured.

When the bamboo strip is subjected to a crushing treatment, it was observed that the obtained bamboo fiber bundle strip still contains fragments or remnants of skin layer material in addition to the main material of partially fragmented fiber bundles of the central bamboo layer. The fragments of skin layer material as such form a contaminant to the fiber bundle strip, because it is a material that has different characteristics from the uniform material of the central bamboo layer.

One significant difference in this context between the material of the skin layers of the culm and the material from the central bamboo layer of the culm, is that the skin layer material has a particularly low permeability for liquid or viscous substances when compared to the material from the central bamboo layer. In fact, the skin layer material is almost impervious to many liquid or viscous substances.

A crushed bamboo fiber bundle strip made according to the prior art, thus contains fragments of skin layer material together with the partially fragmented bamboo fiber bundles, which in practice results in fragments of skin layer material being present between and on the fiber bundles. The skin layer material that is present between and on the fiber bundles and which is virtually impervious, will thus effectively form blockades to the free flowing of a liquid or viscous substance when the fiber bundle strip is impregnated with such a substance during a common post-treatment step of the fiber bundle strip. The extent of impregnation into the bamboo material is thus compromised by the presence of residual skin layer.

In the production of bamboo end products, it is a common treatment step to expose a bamboo fiber bundle strip to liquid or viscous substances which is performed as follows:

For instance, the bamboo fiber bundle strip may be impregnated with an adhesive in liquid or viscous form. After hardening of the adhesive, a unified, composite material is obtained made from bamboo fiber bundle strip material and adhesive, which is widely applicable to the production of panels, boards, beams etc. Furthermore, it may be advantageous to treat the bundle strip with a chemical in liquid or viscous form, in order to improve further properties of the bamboo end product.

The composite material containing bamboo fiber bundle strips, is typically compressed in a subsequent step to obtain in a suitable end product, which in the technological field is often referred to as ‘scrimber’, or ‘bamboo scrimber’.

In this description, the more generic term of ‘bamboo product’ is used to indicate any product made from a multitude of unified bamboo fiber bundle strips.

When applying the methods known from the prior art for producing a bamboo product, the presence of residual skin layer material in the fiber bundle strip should thus be avoided as much as possible, because it effectively compromises an adequate impregnation of the fiber bundle strip by liquid or viscous substances, which results in an unsatisfactory end product.

Furthermore, the presence of residual skin layer material in the fiber bundle strip could also be detrimental in view of other subsequent and common processing steps to which the fiber bundle strip is subjected, such as a thermal treatment or a compressing treatment.

Additionally, the use of milling cutters in a final step of the processing method to remove any residual skin layer material, has a drawback of being relatively costly and cumbersome, because these cutters are prone to substantial wear and tear when applied in this way.

### SUMMARY OF THE INVENTION

The objective of the present invention is to solve the above explained drawbacks of the prior art methods of processing bamboo splits into bamboo strips. In particular the invention aims to reduce the presence of residual skin layer material in the bamboo strips that are produced, while at the same time providing a method which is attractive in regard of optimizing the output of the amount of central bamboo material, and in regard of its operational costs and therefore its viability in general.

According to a first aspect of the present invention, the above objective is achieved by providing a processing method of bamboo splits into bamboo strips of the above indicated type,
wherein in step c) at least the part of the inner skin layer part adjacent to the central bamboo layer is removed by mechanical abrading, and optionally the complete inner skin layer is removed by mechanical abrading.

It is additionally preferred in the invention, that in step c) at least the part of the outer skin layer adjacent to the central bamboo layer is removed by mechanical abrading, and optionally the complete outer skin layer is removed by mechanical abrading.

In the context of the processing method of the invention, the application of the abrasion technique instead of cutting was found to be highly suitable for removing the skin layer by only small increments, which consequently allows for a more precise control of the extent of removal of the skin layer in comparison to the cutting technique.

In practice, it has been observed that when the skin layer is removed by abrasion instead of cutting, it was possible to significantly reduce the amount of residual skin layer material that remains in the obtained bamboo strips. In fact, the amount of residual skin layer could be reduced to an amount well below 5 wt. %. Accordingly, the reduced amount could be 4 wt. % or lower, 3 wt. % or lower, 2 wt. % or lower, or even 1 wt. % or lower. At the same time, it was observed that any unwanted removal of material from the central bamboo material could be kept to a minimum, thus enhancing the efficiency of the method.

Furthermore, it was found that the tools used for the abrasion technique are less prone to wear and tear in comparison to the cutting tools that are commonly used in the prior art.

The processing method according to the first aspect of the invention may further include various preferred features as described herein.

Some preferred features of the invention are explicitly given below:

In the invention, it is preferred that the mechanical abrading is performed by bringing a rotating abrasive brush in contact with the respective parts of the bamboo split that are to be removed, preferably the rotating abrasive brush comprises a rotatable cylinder-shaped structure which is provided with radially extending steel wires.

Such a rotating abrasive brush may alternatively be a rotatable cylinder-shaped structure that includes a massive layer of polycarbide as an abrasive outer surface.

It is furthermore preferred in the invention, that the removal of the inner skin layer in step c) is performed in two stages, which includes a first stage of mechanically cutting the inner skin layer and a subsequent second stage wherein the removal by mechanical abrading is performed.

As such, one may apply in the first stage the coarser technique of mechanically cutting off to remove a large, main part of the inner skin layer, while applying the more precise technique of abrasion for removing the final remaining parts of the inner skin layer, also referred to as remnants, which are present on the central bamboo layer.

It is especially preferably, that during the first stage the inner skin layer is mechanically cut using a rotating milling cutter which is shaped as a wheel having a rotating axis and a width parallel to the rotating axis, which wheel comprises a multitude of radially extending knives that each have a cutting edge extending over the width of the milling cutter, and wherein the cutter is arranged in such a position during the mechanically cutting that its rotating axis is held substantially perpendicular to the longitudinal direction of the bamboo split.

In the invention, it is also preferred that the method comprises an additional step 1) that is performed before step c), which step 1) is a chemical softening treatment wherein the inner skin layer and/or outer skin layer are contacted with a strong base.

Such a pre-treatment of the skin layer further contributes to an adequate subsequent removal of the skin layer by the method. The skin layer may for example be contacted with a sodium hydroxide solution of 0.5 wt. % in water, by submersion over a period of 15-60 minutes.

Further it is preferred in the invention, that the method comprises an additional step 2) that is performed before step c),
in which step 2) the segmental shape of the bamboo split is deformed to a flattened shape, by subjecting the bamboo split to respective counteracting pressure forces from opposed rollers.

In practice it is expedient when the additional step 2), is performed after step b) of removal of the node diaphragms.

By performing additional step 2) the bamboo split—which itself is slightly arched in its width direction—is flattened in its width direction which is practically advantageous in respect of adequately removing the inner and outer skin layers of the bamboo split.

In a second aspect, the invention relates to a bamboo product which is formed from a bamboo material which comprises a unified multitude of bamboo fiber bundle strips, wherein the bamboo fiber bundle strips are obtained by the method according to the first aspect of the invention.

The bamboo product may further include several preferred features which are defined in the corresponding appended claims.

In a third aspect, the invention relates to a processing system for processing bamboo splits which are segmental and longitudinal parts of a bamboo culm, in order to produce bamboo strips from such bamboo splits, wherein the processing preferably is performed in accordance with a method as defined by the first aspect of the invention, the bamboo split having an inner skin layer and outer skin layer and a central bamboo layer in between, and the processing system comprises:
conveying rollers for conveying the bamboo splits in their longitudinal direction through various subsequent processing stations which comprise:
i) a cutting station for mechanical removal of bamboo node diaphragms present on the inner skin layer of the bamboo split, which cutting station comprises a rotary knife that cuts off the node diaphragms upon passage of the bamboo split through the cutting station;
ii) a de-skinning station for mechanically removing the inner skin layer and outer skin layer from the bamboo split, which de-skinning station comprises an abrasive rotating brush that abrades at least the part of the inner skin layer adjacent to the central bamboo layer, and preferably the complete inner skin layer, upon passage of the bamboo split through the de-skinning station.
   The processing system may further include several preferred features which are defined in the corresponding appended claims.

### BRIEF DESCRIPTION OF THE DRAWINGS

The terms Fig., Figs., Figure, and Figures are used interchangeably in the specification to refer to the corresponding figures in the drawings.

The invention is further explained by various preferred embodiments that are illustrated in the accompanying figures, wherein:

FIG. 1 shows a bamboo culm which is split to provide bamboo split as a starting material for the processing method, and a bamboo fiber bundle strip as a possible final product of the method;

FIG. 2 shows cross-sections of the bamboo split and bamboo strip during successive stages (I up to VI) of the processing method according to a first preferred embodiment;

FIG. 3 shows schematically a processing system wherein bamboo splits are conveyed through various subsequent processing stations;

FIG. 4 shows cross-sections of the bamboo split and bamboo strip during successive stages of the processing method according to a second preferred embodiment;

FIG. 5 shows in perspective an abrasive rotating brush that is used during the specific stage V of the method.

### DESCRIPTION OF THE INVENTION

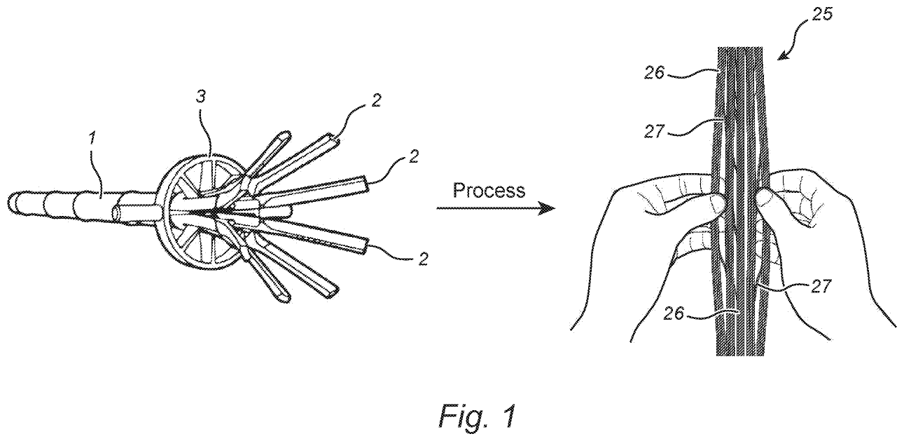

FIG. 1 shows on the left-hand side, a bamboo culm 1 that is forced through a radial splitting apparatus 3, so that segmental, longitudinal bamboo splits 2 are formed. These bamboo splits 2 are the starting material which are individually processed by the method of the invention. On the right-hand side of FIG. 1, a bamboo fiber bundle strip 25 is shown that can be obtained by the method of the invention, plus an additional crushing treatment with high pressure rollers. During the crushing treatment by high pressure rollers the central bamboo layer material is partially fragmented into separate longitudinal fiber bundles 26, which are still partially cross-linked to each other at certain positions along the length of these fiber bundles by intermediate fiber bundle cross-linkages 27.

It is noted that the crushing treatment that is performed, is based on a prior art method described by Coleman in U.S. Pat. No. 4,232,067, wherein wood is broken down, without effecting complete separation, into parallel aligned longitudinal strands of fiber bundles by applying force to the material by pressure rollers.

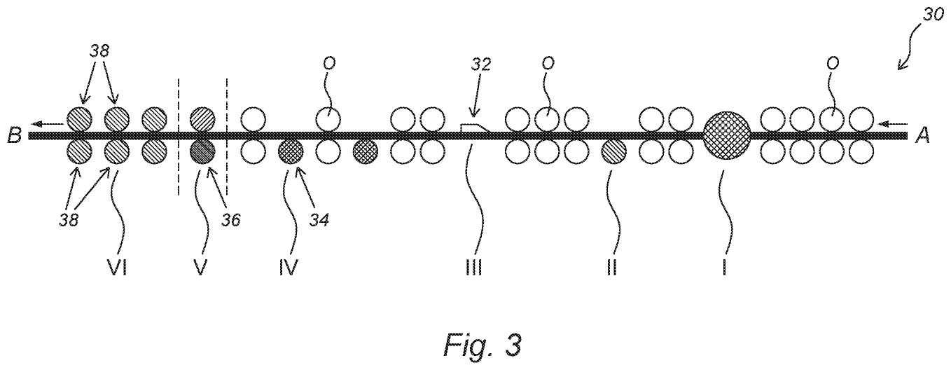

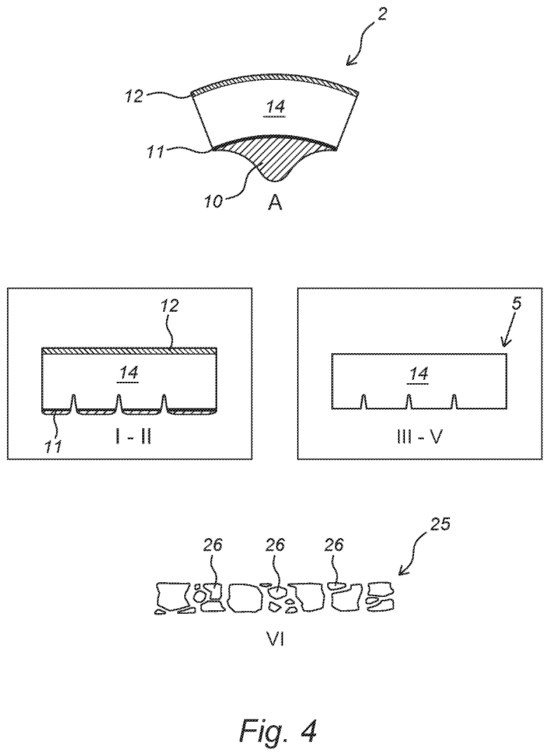

In particular the crushing is executed as described in claims 9-17 of the Coleman patent. Furthermore, FIGS. 3 and 4 in the Coleman patent specify in a schematic way the appearance of the material after the crushing step and the appearance of the parallel aligned, not completely separated, longitudinal strands of fiber bundles.

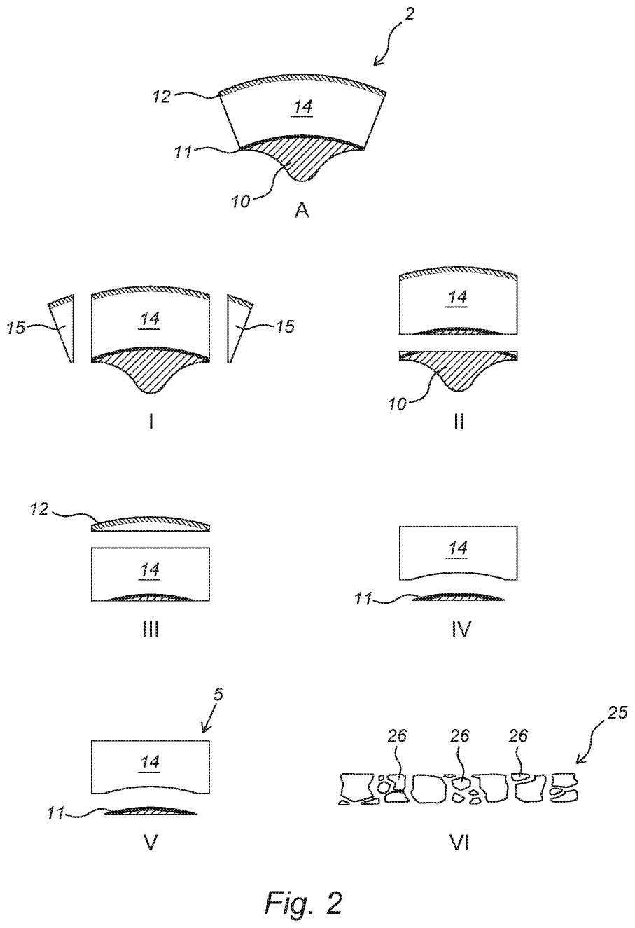

FIG. 2 shows cross-sections of the bamboo split 2 and bamboo strip 5 during successive stages I through VI, of the processing method according to a first preferred embodiment.

At the initial stage indicated by A, a bamboo split 2 is provided having a bamboo node diaphragm 10, an inner skin layer 11, an outer skin layer 12, and a central bamboo layer 14 in between both layers.

At stage I, the two lateral sides of the bamboo split are cut to a pre-determined width by cutting off the lateral side parts 15, such that the obtained lateral sides of the bamboo split are more or less parallel to each other.

Next at stage II, the bamboo node diaphragms 10 are removed by mechanical cutting.

At subsequent stage III the outer skin layer 12 is removed by mechanical cutting.

At stage IV, a first part of the inner skin layer 11 is removed by mechanical cutting.

At stage V, the final part of the inner skin layer 11 which is directly adjacent to the central bamboo layer 14 is removed by mechanical abrading. After stage V, a so-called bamboo strip 5 is obtained which can be characterized as a de-skinned version of bamboo split 2, basically formed by the material of the central bamboo layer 14.

At stage VI, the bamboo strip 5 has been subjected to a crushing treatment by which the central bamboo layer material 14 is partially fragmented into separate longitudinal fiber bundles 26, which are still partially cross-linked to each other at certain positions along the length of these fiber bundles.

FIG. 3 shows, in longitudinal cross-section, schematically a processing system 30 wherein bamboo splits are conveyed through successive processing stations I through VI. The bamboo splits are conveyed in their longitudinal direction by virtue of conveying rollers 0, starting at initial point A. The numbering of the processing stations I through VI corresponds to numbering of the processing stages I through VI of FIG. 2 which were explained above.

At station I, the two lateral sides of the bamboo split 2 are cut to a pre-determined width by rotary knives, upon passage of the bamboo split through the station I.

Station II is a cutting station for mechanical removal of bamboo node diaphragms 10 present on the inner skin layer of the bamboo split 2, which cutting station comprises a rotary knife that cuts off the node diaphragms upon passage of the bamboo split through the cutting station.

Stations III, IV and V are de-skinning stations for mechanically removing the outer skin layer and the inner skin layer from the bamboo split.

Station III contains a stationary knife along which the outer skin layer is conveyed, such that the outer skin layer 12 is removed. Alternatively, to the stationary knife 32, an abrasive rotating brush may be used for removing the outer skin layer 12.

Station IV contains rotating knives 34 along which the inner skin layer is conveyed, for mechanically cutting off a first part of the inner skin layer. Station V contains an abrasive rotating brush 36 along which the remaining inner skin layer is conveyed, such that the second part of the inner skin layer adjacent to the central bamboo layer 14 is fully removed.

It is noted that within the scope of the invention, the station IV with rotating knives 34 may be dispensed with, such that upon passage of the station V the complete inner skin layer is removed solely by an abrasive rotating brush 36.

Station VI is a crushing station which contains a multitude of pairs of opposed rollers 38 between which the bamboo strip 5 is conveyed that is delivered from station V, and wherein the respective rollers 38 exert counteracting pressure forces on the opposing top and bottom surfaces of the bamboo strip 5 when it is conveyed between the opposed pressure rollers. After crushing of the bamboo strip 5, a bamboo fiber bundle strip 25 is obtained which has a structure corresponding to the cross-section VI in FIG. 2.

FIG. 4 shows cross-sections of the bamboo split 2 and bamboo strip 5 during successive stages A through VI, of the processing method according to a second preferred embodiment. This embodiment is a variant of the first preferred embodiment shown in FIG. 2, and identical stages that are included in both embodiments are numbered in the same way.

At the initial stage indicated by A, a bamboo split 2 is provided having a bamboo node diaphragm 10, an inner skin layer 11, an outer skin layer 12, and a central bamboo layer 14 in between both layers.

The stage I of FIG. 2 is dispensed with in this second embodiment, while the stage II of removing the node diaphragms is adhered to, and performed in accordance with stage II shown in FIG. 2.

The segmental bamboo split obtained at stage II (and shown in FIG. 2) is subsequently deformed to a flattened shape, by subjecting the bamboo split to respective counteracting pressure forces from opposed rollers.

At subsequent stages III, IV and V the flattened bamboo split is de-skinned in accordance with the above description of FIG. 2. It is noted that the de-skinning may be performed by using merely abrasive rotating brushes as indicated above, or alternatively by combining such brushes with rotating and stationary knives as described above.

Finally, the obtained bamboo strip 5 is subjected to a crushing treatment by which the central bamboo layer material 14 is partially fragmented into separate longitudinal fiber bundles 26, which are still partially cross-linked to each other at certain positions along the length of these fiber bundles.

The obtained bamboo fiber bundle strip 25 shown in the above figures, has a low amount of residual skin layer material, which amount is well below 5 wt. %, such as 4 wt. % or lower, 3 wt. % or lower, 2 wt. % or lower, or preferably 1 wt. % or lower.

Accordingly, the fiber bundle strips 25 obtained by the invention are highly suitable for manufacturing bamboo scrimber products of an improved quality which will no longer be compromised by detrimental amounts of residual skin layer material.

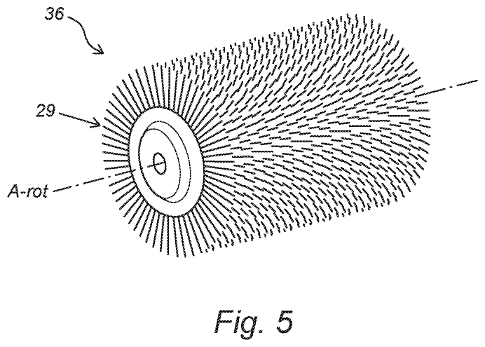

FIG. 5 shows in perspective an abrasive rotating brush 36 that is used during the specific stage V of the method, which comprises a rotatable cylinder-shaped structure having a rotating axis A-rot, which is provided with radially extending steel wires 29.

A general advantage of these wires 29 is that they are resiliently flexible, which allows for adapting to the specific shape of the surface that is to be abraded. In particular, the abrasion of the thin layer 11 of residual inner skin material that is present at the previous stage can be performed adequately.

1. [symbol] of mechanically processing a bamboo split which is a segmental and longitudinal part of a bamboo culm,
by which method a bamboo strip is produced, and the method comprises the following steps:
a) providing a bamboo split which has an inner skin layer and outer skin layer and a central bamboo layer in between;
b) mechanically removing bamboo node diaphragms present on the inner skin layer of the bamboo split;
c) mechanically removing the inner skin layer and outer skin layer from the bamboo split in order to obtain a bamboo strip;
characterized in that in step c) at least the part of the inner skin layer part adjacent to the central bamboo layer is removed by mechanical abrading, and optionally the complete inner skin layer is removed by mechanical abrading.

2. According to claim 1, wherein in step c) at least the part of the outer skin layer adjacent to the central bamboo layer is removed by mechanical abrading, and optionally the complete outer skin layer is removed by mechanical abrading.

3. According to claim 1, wherein in step b) the bamboo node diaphragms are removed by mechanical cutting.

4. According to [symbol] , wherein the mechanical abrading is performed by bringing a rotating abrasive brush in contact with the respective parts of the bamboo split that are to be removed, preferably the rotating abrasive brush comprises a rotatable cylinder-shaped structure which is provided with radially extending steel wires.

5. According to claim 4, wherein the rotating abrasive brush has a rotating axis, and the abrasive rotating brush is arranged in such a position during the mechanical abrading, that its rotating axis is held substantially perpendicular to the longitudinal direction of the bamboo split.

6. According to [symbol] , wherein the removal of the inner skin layer in step c) is performed in two stages, which includes a first stage of mechanically cutting the inner skin layer and a subsequent second stage wherein the removal by mechanical abrading is performed.

7. According to claim 6, wherein during the first stage the inner skin layer is mechanically cut using a rotating milling cutter which is shaped as a wheel having a rotating axis and a width parallel to the rotating axis, which wheel comprises a multitude of radially extending knives that each have a cutting edge extending over the width of the milling cutter, and wherein the cutter is arranged in such a position during the mechanically cutting that its rotating axis is held substantially perpendicular to the longitudinal direction of the bamboo split.

8. According to [symbol] , which comprises an additional step 1) that is performed before step c),
which step 1) is a chemical softening treatment wherein the inner skin layer and/or outer skin layer are contacted with a strong base.

9. According to [symbol] , which comprises an additional step 2) that is performed before step c),
in which step 2) the segmental shape of the bamboo split is deformed to a flattened shape, by subjecting the bamboo split to respective counteracting pressure forces from opposed rollers.

10. According to [symbol] , which comprises an additional step 3), that is performed before step c),
in which step 3) opposed lateral sides of the bamboo split are cut to a pre-determined width.

11. According to [symbol] , wherein the bamboo strip that is produced by the method has a low amount of residual skin layer material, which amount is well below 5 wt. %, such as 4 wt. % or lower, 3 wt. % or lower, 2 wt. % or lower, or preferably 1 wt. % or lower.

12. According to [symbol] , which further comprises an additional step 4) that is performed after step c),
in which step 4) the bamboo strip that is produced by the method is subjected to a crushing treatment by which the central bamboo layer material is partially fragmented into separate longitudinal fiber bundles, which are still partially cross-linked to each other at certain positions along the length of these fiber bundles.

13. According to [symbol] , wherein one or more steps of the method are performed while the bamboo splits and bamboo strips are transported in a direction that aligns with the longitudinal direction of the bamboo splits and bamboo strips, preferably by the use of conveying rollers.

14. According to claim 12, which further comprises one or more of the following treatments of the bamboo fiber bundle strip that is obtained by step 4):
a thermal treatment;
an impregnation with a fluid material, and/or
a compressing treatment,
in order to produce a bamboo material that is suitable for predetermined applications.

15. [symbol] product which is formed from a bamboo material which comprises a unified multitude of bamboo fiber bundle strips, wherein the bamboo fiber bundle strips are obtained by the method of claim 12, and preferably the bamboo material is obtained by the method.

16. [symbol] product according to claim 15, wherein the bamboo material is a composite material, which comprises a secondary material that is dispersed over and around the fiber bundles, which secondary material preferably comprises an adhesive material.

17. [symbol] system for processing bamboo splits which are segmental and longitudinal parts of a bamboo culm, in order to produce bamboo strips from such bamboo splits, wherein the processing preferably is performed in accordance with a method as defined in [symbol] , the bamboo split having an inner skin layer and outer skin layer and a central bamboo layer in between, and the processing system comprises:
conveying rollers for conveying the bamboo splits in their longitudinal direction through various subsequent processing stations which comprise:
i) a cutting station for mechanical removal of bamboo node diaphragms present on the inner skin layer of the bamboo split, which cutting station comprises a rotary knife that cuts off the node diaphragms upon passage of the bamboo split through the cutting station;
ii) a de-skinning station for mechanically removing the inner skin layer and outer skin layer from the bamboo split, which de-skinning station comprises an abrasive rotating brush that abrades at least the part of the inner skin layer part adjacent to the central bamboo layer, and preferably the complete inner skin layer, upon passage of the bamboo split through the de-skinning station.

18. [symbol] system according to claim 17, wherein the de-skinning station ii) further comprises, a rotating milling cutter for mechanically cutting the inner skin layer, which is shaped as a wheel having a rotating axis and a width parallel to the rotating axis, which wheel comprises a multitude of radially extending knives that each have a cutting edge extending over the width of the milling cutter, and wherein the cutter is arranged in such a position during the mechanically cutting that its rotating axis is held substantially perpendicular to the longitudinal direction of the bamboo split,
which milling cutter is positioned upstream of the abrasive rotating brush in de-skinning station ii).

19. [symbol] system according to claim 17, wherein the de-skinning station ii) further comprises an abrasive rotating brush that abrades at least the part of the outer skin layer adjacent to the central bamboo layer, and preferably the complete outer skin layer, upon passage of the bamboo split through the de-skinning station.

20. [symbol] system according to [symbol] , which further comprises:
a bamboo split flattening station iii), which comprises opposed rollers between which the bamboo split is conveyed, wherein the respective rollers exert counteracting pressure forces on the bamboo split when the bamboo split is conveyed between the opposed rollers.

21. [symbol] system according to [symbol] , which further comprises downstream of station ii):
a bamboo strip crushing station iv), which comprises opposed rollers between which the bamboo strip is conveyed that is delivered from station ii), and wherein the respective rollers exert counteracting pressure forces on the opposing top and bottom surfaces of the bamboo strip when it is conveyed between the opposed rollers.
